(19) United States
(12) Patent Application Publication
(10) Pub. No.: US 2014/0305154 A1
(43) Pub. Date: Oct. 16, 2014

(54) CHANNEL SWITCHING VALVE AND VEHICLE AIR CONDITIONING DEVICE PROVIDED WITH CHANNEL SWITCHING VALVE

(71) Applicant: Calsonic Kansei Corporation, Saitama-shi, Saitama (JP)

(72) Inventors: Hiroki Yoshioka, Saitama-shi (JP); Hidekazu Miyoshi, Tokyo (JP)

(21) Appl. No.: 14/364,577

(22) PCT Filed: Nov. 27, 2012
(86) PCT No.: PCT/JP2012/080558

§ 371 Date: Jun. 11, 2014

(30) Foreign Application Priority Data
Dec. 16, 2011 (JP) 2011-275558

(51) Int. Cl. F25B 13/00; F16K 11/087

(52) U.S. Cl. CPC F25B 13/00; F16K 11/087
USPC 62/324.6; 137/625; 137/625.47

(57) ABSTRACT

The invention is provided with: a housing having a refrigerant inlet and plurality of refrigerant outlets, through which a refrigerant flows in or out; and a valve body having refrigerant channels which are movably accommodated in the housing and can be selectively switched between communicating with the refrigerant inlet and with each of the refrigerant outlets; the refrigerant channels being partially constituted of an orifice and able to be selectively switched between a route passing through the orifice and a route not passing therethrough.

### FIELD OF INVENTION

The present invention relates to a channel switching valve which is provided in a vapor compression type refrigerating cycle, and a vehicle air conditioning device provided with the channel switching valve.

### BACKGROUND ART

For example, in an electric vehicle, heat from a drive source can be hardly utilized for heating an inside of a passenger compartment. Therefore, there are proposed various vehicle air conditioning devices which use a refrigerant circulating a compression type refrigerating cycle as a cold source or a heat source (refer, for example, to Patent Literature 1 and Patent Literature 2).

The compression type refrigerating cycle of the vehicle air conditioning device mentioned above includes a compressor which compresses a refrigerant, an indoor condenser which performs heat exchange between the refrigerant compressed by the compressor and air supplied into a passenger compartment so as to heat the air, an outdoor heat exchanger which performs heat exchange between the refrigerant and air outside the passenger compartment, a decompressing unit configured to decompress the refrigerant, and an indoor evaporator which performs heat exchange between the refrigerant decompressed by the decompressing unit and the air supplied into the passenger compartment so as to cool the air. Further, it is necessary to make the outdoor heat exchanger function as a condenser, make the outdoor heat exchanger function as an evaporator, and bypass the outdoor heat exchanger so as to prevent the outdoor heat exchanger from functioning as a heat exchanger. Therefore, a plurality of refrigerant channels, a channel switching unit configured to switch them, and a decompressing unit have been conventionally arranged in an upstream of the outdoor heat exchanger.

### CITATION LIST

### Patent Literature

Patent Literature 1: Japanese Patent Application Laid-Open Publication No. 2000-203249 (Japanese Patent No. 4341093)

Patent Literature 2: Japanese Patent Application Laid-Open Publication No. Hei 10-287125 (Japanese Patent No. 3799732)

### SUMMARY OF INVENTION

### Technical Problem

Accordingly, in the conventional example, a high cost, a heavy weight and an increase of an installing space are caused, and a reduction in the number of parts is desired. Further, since a piping joint is necessary, there is a concern that a man hour for connecting work is increased. Further, in the case that each of a plurality of channel switching units is constructed by an electromagnetic control valve, the number of wiring connectors and a harness connecting man hour are increased since a plurality of coils are required for controlling the valve elements, so that there is a problem that a cost is increased also in this regard.

Therefore, the present invention is made for solving the problem mentioned above, and has an object to provide a channel switching valve which can switch a plurality of refrigerant channels, and a vehicle air conditioning device provided with the channel switching valve.

### Solution to Problem

A channel switching valve according to the present invention is a channel switching valve including a housing having a refrigerant inlet and a plurality of refrigerant outlets through which a refrigerant flows in and out, a valve body having refrigerant channels which are movably accommodated in the housing and can selectively switch communication between the refrigerant inlet and each of the refrigerant outlets, wherein the refrigerant channels are partly constructed by an orifice, and can be selectively switched between a route which passes through the orifice and a route which does not pass through the orifice.

It is preferable that the housing has a refrigerant inlet to which the refrigerant passing through an indoor condenser which performs heat exchange between the refrigerant compressed by a compressor and air supplied into a passenger compartment and heats the air is conducted, a first refrigerant outlet which conducts the refrigerant to an outdoor heat exchanger performing heat exchange between the refrigerant and air outside the passenger compartment, and a second refrigerant outlet which conducts the refrigerant to a bypass passage flowing the refrigerant to an indoor evaporator performing heat exchange between the refrigerant and air inside the passenger compartment while bypassing the outdoor heat exchanger, and the valve body can be switched among a first switching position which communicates between the refrigerant inlet and the second refrigerant outlet, a second switching position which communicates between the refrigerant inlet and the first refrigerant outlet by a switching channel passing through the orifice, and a third switching position which communicates between the refrigerant inlet and the first refrigerant outlet.

It is preferable that the valve body is a ball valve which can vary the switching position by rotation.

In a switching process of each of the switching positions, the switching position can be switched by partly communicating between the refrigerant inlet and the first refrigerant outlet or the second refrigerant outlet.

It is preferable that a control for restricting a rotating speed of the compressor is carried out, in a section which is fully closed in the switching process to each of the switching positions.

A vehicle air conditioning device according to the present invention includes a compressor which compresses a refrigerant; an indoor condenser which performs heat exchange between the refrigerant compressed by the compressor and air supplied into a passenger compartment so as to heat the air; an outdoor heat exchanger which performs heat exchange between the refrigerant and air outside the passenger compartment; an indoor evaporator which performs heat exchange between the refrigerant and the air supplied into the passenger compartment so as to cool the air; and a channel switching valve having a refrigerant inlet to which the refrigerant passing through the indoor condenser is conducted, a first refrigerant outlet which flows the refrigerant to the outdoor heat exchanger, and a second refrigerant outlet which conducts the refrigerant to a bypass passage bypassing the outdoor heat exchanger, and being capable of switching among a first switching position which communicates between the refrigerant inlet and the second refrigerant outlet, a second switching position which communicates between the refrigerant inlet and the first refrigerant outlet by a switching channel passing through an orifice, and a third switching position which communicates between the refrigerant inlet and the first refrigerant outlet.

### BRIEF DESCRIPTION OF DRAWINGS

FIG. 1 shows an embodiment according to the present invention and is a configuration diagram of a vehicle air conditioning device.

FIG. 2 shows an embodiment according to the present invention and is a cross sectional view of a channel switching valve.

FIGS. 3(a) to 3(c) show an embodiment according to the present invention, wherein FIG. 3(a) is a cross sectional view of a channel switching valve which is positioned at a first switching position (an inside air heat absorbing heating operation time), FIG. 3(b) is a cross sectional view of the channel switching valve which is positioned at a second switching position (an outside air heat absorbing heating operation time), and FIG. 3(c) is a cross sectional view of the channel switching valve which is positioned at a third switching position (a cooling reheat operation time).

FIGS. 4(a) and 4(b) show an embodiment according to the present invention, wherein FIG. 4(a) is a cross sectional view of a channel switching valve in which a valve body is in an intermediate opening state, and FIG. 4(b) is a cross sectional view of the channel switching valve in which the valve body is in a closed state.

FIG. 5 shows an embodiment according to the present invention and is a view showing a refrigerant route at the inside air heat absorbing heating operation time.

FIG. 6 shows an embodiment according to the present invention and is a view showing a refrigerant route at the outside air heat absorbing heating operation time.

FIG. 7 shows an embodiment according to the present invention and is a view showing a refrigerant route at the cooling reheat operation time.

### DESCRIPTION OF EMBODIMENTS

A description will be given below of embodiments according to the present invention on the basis of the accompanying drawings.

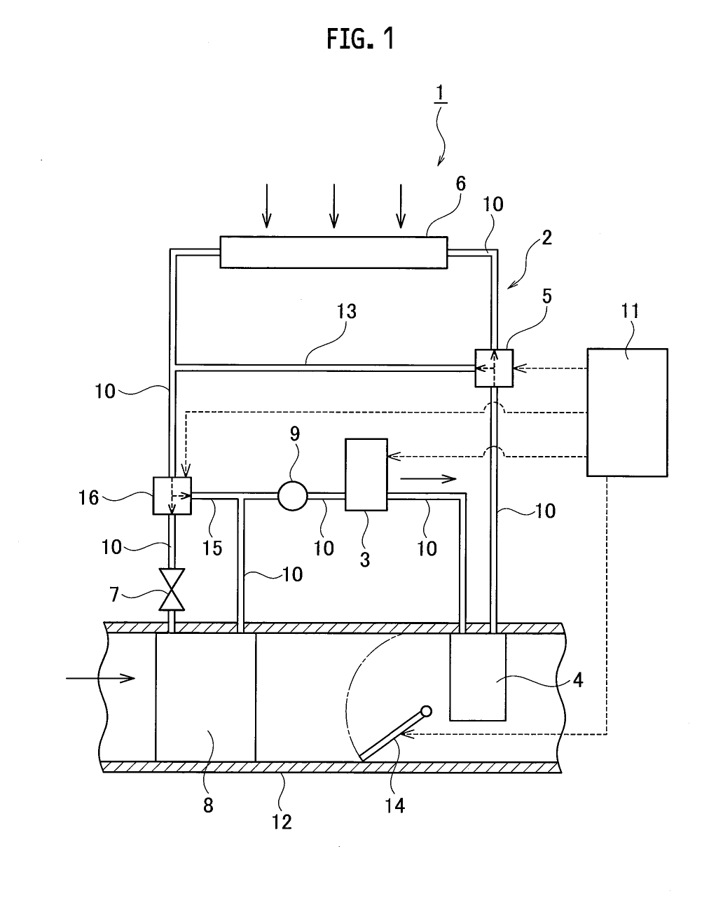

As shown in FIG. 1, a vehicle air conditioning device 1 is provided with a vapor compression type refrigerating cycle 2. The vapor compression type refrigerating cycle 2 includes a compressor 3 which compresses a refrigerant, an indoor condenser 4 which performs heat exchange between the refrigerant compressed by the compressor 3 and air supplied into a passenger compartment so as to heat the air, a channel switching valve 5 which is arranged in a downstream of the indoor condenser 4, an outdoor heat exchanger 6 which is arranged in a downstream of the channel switching valve 5, a temperature type expansion valve 7 which is arranged in a downstream of the outdoor heat exchanger 6 and corresponds to a decompressing unit configured to decompress the refrigerant, an indoor evaporator 8 which is arranged in a downstream of the temperature type expansion valve 7, and an accumulator 9 which is arranged in a downstream of the indoor evaporator 8, and these elements are connected by each of refrigerant pipings 10. Further, the vapor compression type refrigerating cycle 2 has a first bypass passage 13 which connects an outlet side of the channel switching valve 5 and an outlet side of the outdoor heat exchanger 6 and bypasses the outdoor heat exchanger 6, a second bypass passage 15 which bypasses the indoor evaporator 8, and a three-way valve 16 which is provided at a connection position between an upstream side end of the second bypass passage 15 and the refrigerant piping 10.

The compressor 3 is, for example, a vane type one, in which on and off and its rotating speed are controlled by a command from a control unit 11.

The indoor condenser 4 is arranged within an air conditioning case 12 and in a downstream of the indoor evaporator 8. The indoor condenser 4 performs heat exchange between the high-temperature and high-pressure refrigerant compressed by the compressor 3 and the air passing through an inner side of the air conditioning case 12 (the air supplied into the passenger compartment). The indoor condenser 4 heats the air on the basis of a heat radiating action of the refrigerant.

The outdoor heat exchanger 6 is arranged, for example, within an engine room. The outdoor heat exchanger 6 performs heat exchange between the refrigerant passing through the indoor condenser 4 and the air outside the passenger compartment.

The temperature type expansion valve 7 has a temperature sensing tube portion (not shown) which is attached to an outlet side of the indoor evaporator 8, and automatically adjusts a valve opening degree so that a refrigerant overheat (superheat) in the outlet side of the indoor evaporator 8 is maintained at a predetermined value.

The indoor evaporator 8 is arranged within the air conditioning case 12 and in an upstream of the indoor condenser 4. The indoor evaporator 8 performs heat exchange between the refrigerant decompressed by the temperature type expansion valve 7 and the air passing through an inner side of the air conditioning case 12 (the air supplied into the passenger compartment). The indoor evaporator 8 cools the air on the basis of a heat absorbing action of the refrigerant so as to perform dehumidification.

The accumulator 9 temporarily reserves a surplus refrigerant within the refrigerant fed from the indoor evaporator 8 and feeds only a gas refrigerant to the compressor 3.

The air conditioning case 12 is provided with an air mix door 14 which adjusts an air distribution ratio between an air blasting passing through the indoor condenser 4 and an air blasting bypassing the indoor condenser 4. A downstream side of the air mix door 14 is provided with a foot blowout port, a defroster blowout port and a vent blowout port, the illustration of which is omitted. Further, an upstream side of the air conditioning case 12 (a left side in FIG. 1) is provided with an outside air introduction port which introduces the air outside the passenger compartment, an inside air introduction port which introduces the air inside the passenger compartment, an intake door which opens and closes the outside air introduction port and the inside air introduction port, and an air blasting machine, the illustration of which is omitted.

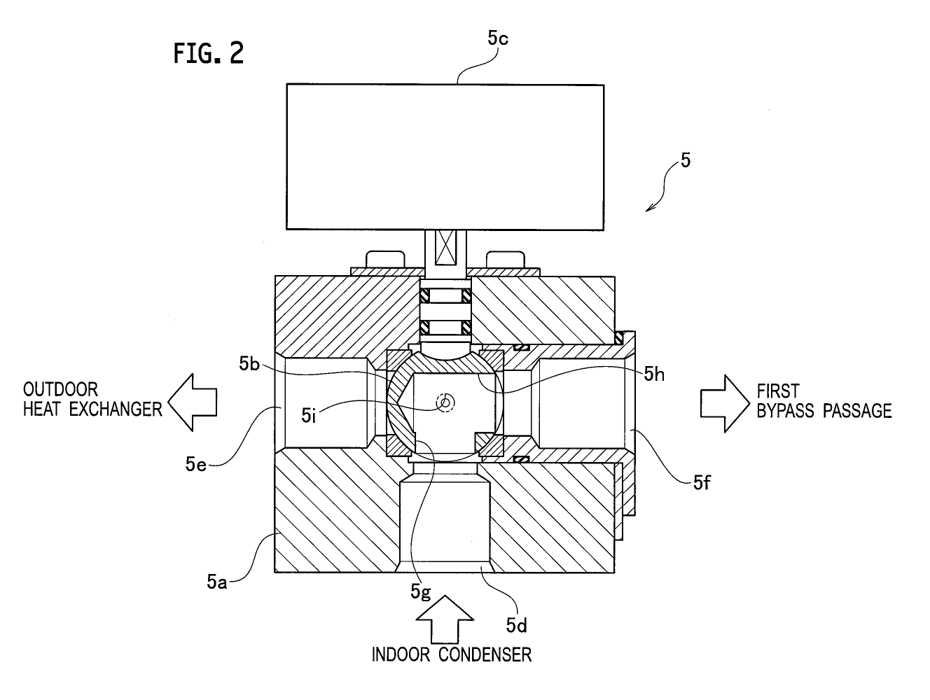

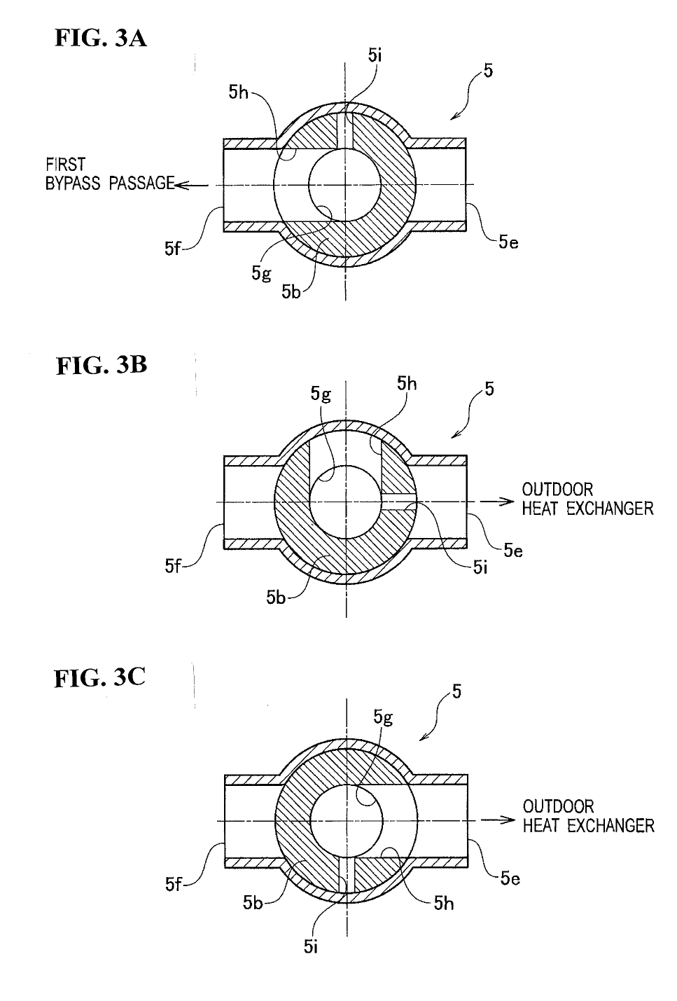

As shown in FIGS. 2 and 3, the channel switching valve 5 has a housing 5a, a valve body 5b which is rotatably accommodated in the housing 5a and is constructed by a ball valve varying the switching position by rotation, and an actuator 5c which is provided in an outer portion of the housing 5a, is controlled by the control unit 11 and rotates the valve body 5b.

The housing 5a has a refrigerant inlet 5d which is connected to the indoor condenser 4, a first refrigerant outlet 5e which is connected to the outdoor heat exchanger 6, and a second refrigerant outlet 5f which is connected to the first bypass passage 13 bypassing the outdoor heat exchanger 6.

The valve body 5b has an inflow passage 5g which is connected to the refrigerant inlet 5d, an outflow passage 5h which can be connected to the first refrigerant outlet 5e and the second refrigerant outlet 5f, and an orifice 5i which can be connected to the first refrigerant outlet 5e. The refrigerant channel is constructed by the inflow passage 5g, the outflow passage 5h and the orifice 5i. In other words, the valve body 5b has the refrigerant channel which can selectively switch communication between the refrigerant inlet 5d and each of the refrigerant outlets 5e and 5f, and the refrigerant channel is partly constructed by the orifice 5i, and can be selectively switched between a route which passes through the orifice 5i and a route which does not pass through the orifice 5i.

Next, a description will be given of a specific structure of the valve body 5b. The inflow passage 5g extends in an axial direction of the valve body 5b (a vertical direction in FIG. 2). Each of the outflow passage 5h and the orifice 5i extends in a direction which is orthogonal to the axial direction, and an axial direction of the orifice 5i is deviated at 90 degrees in a rotating direction of the valve body 5b from an axial direction of the outflow passage 5h. The orifice 5i is constructed by a narrow hole, and the inflow passage 5g and the outflow passage 5h are constructed by a hole having a comparatively large diameter.

In the channel switching valve 5, the refrigerant from the indoor condenser 4 flows into the inflow passage 5g of the valve body 5b from the refrigerant inlet 5d. Further, since the outflow passage 5h is connected to the second refrigerant outlet 5f in the case that the valve body 5b exists at a first switching position which communicates between the refrigerant inlet 5d and the second refrigerant outlet 5f, as shown in FIG. 3(a), the refrigerant flows out of the outflow passage 5h to the first bypass passage 13. In this case, since the orifice 5i is connected to none of the first refrigerant outlet 5e and the second refrigerant outlet 5f, that is, the orifice 5i is closed, the refrigerant does not flow out via the orifice 5i.

Since the orifice 5i is connected to the first refrigerant outlet 5e in the case that the valve body 5b rotates at 90 degrees in a clockwise direction to a second switching position which communicates between the refrigerant inlet 5d and the first refrigerant outlet 5e by the switching channel passing through the orifice 5i, as shown in FIG. 3(b), the refrigerant flows out to the outdoor heat exchanger 6 via the orifice 5i. In other words, it is possible to decompress the refrigerant by the orifice 5i so as to flow the refrigerant to the outdoor heat exchanger 6 by rotating the valve body 5b to the second switching position. In this case, since the outflow passage 5h is connected to none of the first refrigerant outlet 5e and the second refrigerant outlet 5f, that is, the outflow passage 5h is closed, the refrigerant does not flow out via the outflow passage 5h.

Since the outflow passage 5h is connected to the first refrigerant outlet 5e in the case that the valve body 5b rotates at 180 degrees in a clockwise direction to a third switching position which communicates between the refrigerant inlet 5d and the first refrigerant outlet 5e, as shown in FIG. 3(c), the refrigerant flows out to the outdoor heat exchanger 6 via the outflow passage 5h. In other words, in the case that the valve body 5b exists at the third switching position, it is possible to flow the refrigerant without decompressing it. In this case, since the orifice 5i is connected to none of the first refrigerant outlet 5e and the second refrigerant outlet 5f, that is, the orifice 5i is closed, the refrigerant does not flow out via the orifice 5i.

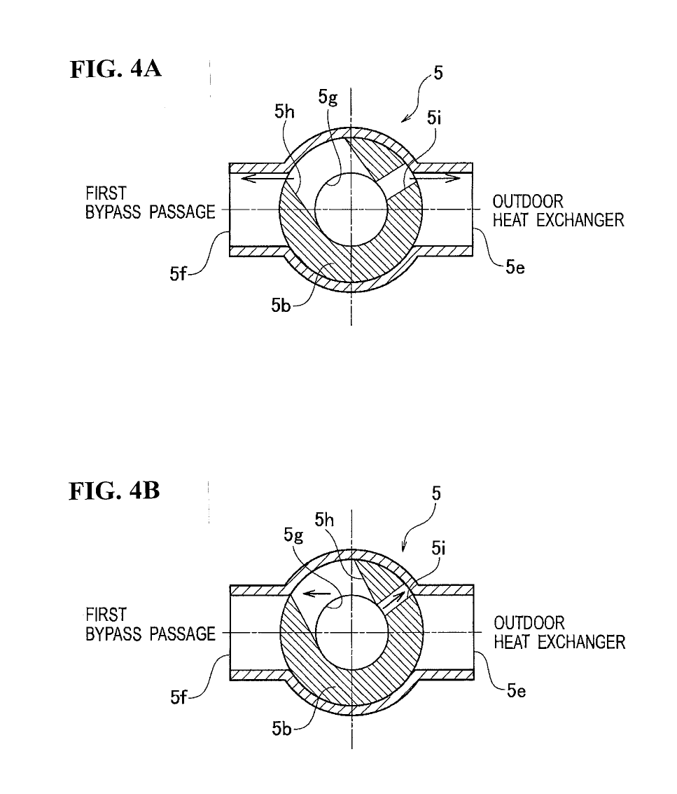

Further, in the switching process of each of the switching positions of the valve body 5b, the switching position is switched while partly communicating between the refrigerant inlet 5d and the first refrigerant outlet 5e or the second refrigerant outlet 5f. For example, as shown in FIG. 4(a), in the process of switching the valve body 5b from the first switching position to the second switching position, the orifice 5i is communicated with the first refrigerant outlet 5e or the outflow passage 5h is communicated with the second refrigerant outlet 5f. Accordingly, the refrigerant inlet 5d is partly communicated with the first refrigerant outlet 5e or the second refrigerant outlet 5f.

Each of the channel switching valve 5 and the three-way valve 16 is switched by the control unit 11.

The control unit 11 controls the compressor 3, the channel switching valve 5, the three-way valve 16, the air mix door 14 and the like on the basis of input data from an operation portion (not shown) and detected date of various sensors (not shown). A description will be given of control contents of the control unit 11 in the following place about a motion of the vehicle air conditioning device 1.

Next, a description will be given of the motion of the vehicle air conditioning device 1. In the cooling reheat operation, the channel switching valve 5 is switched to the third switching position in FIG. 3(c), that is, in such a manner that the refrigerant flows to the outdoor heat exchanger 6 side, and the three-way valve 16 is switched in such a manner that the refrigerant flows to the indoor evaporator 8 side, respectively.

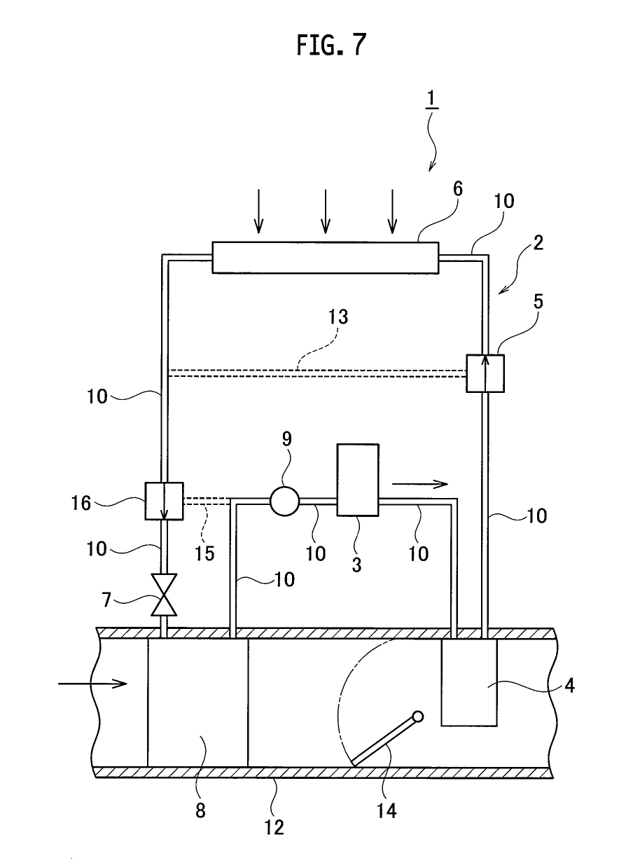

The refrigerant compressed by the compressor 3 circulates in a refrigerant route which passes through the indoor condenser 4, the channel switching valve 5, the outdoor heat exchanger 6, the three-way valve 16, the temperature type expansion valve 7, the indoor evaporator and the accumulator 9, as shown in FIG. 7. The high-temperature and high-pressure refrigerant compressed by the compressor 3 radiates heat to the air by the indoor condenser 4 and the outdoor heat exchanger 6. The refrigerant which comes to a low temperature by the heat radiation and is set to a low pressure by the temperature type expansion valve 7 absorbs heat from the air by the indoor evaporator 8. Accordingly, the air blasting passing through the inner side of the air conditioning case 12 is cooled by the indoor evaporator 8, and a part or all thereof is reheated by the indoor condenser 4. As a result, the air passing through the inner side of the air conditioning case 12 is controlled to a cold air having a desired temperature.

In the inside air heat absorbing heating operation, the channel switching valve 5 is switched to the first switching position in FIG. 3(a), that is, in such a manner that the refrigerant flows to the first bypass passage 13 side, and the three-way valve 16 is switched in such a manner that the refrigerant flows to the indoor evaporator 8 side, respectively. The air mix door 14 is switched, for example, to a full-open position.

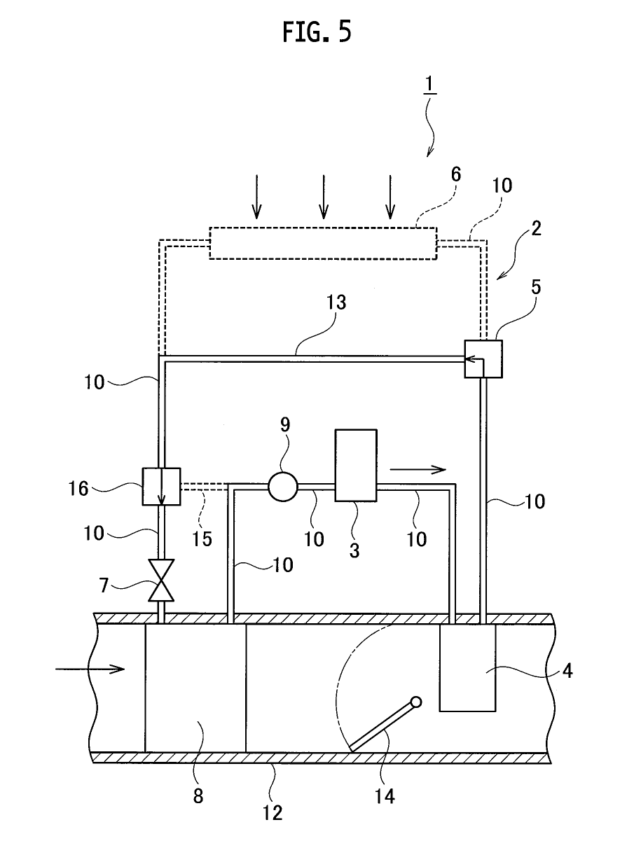

The refrigerant compressed by the compressor 3 circulates in a refrigerant route which passes through the indoor condenser 4, the channel switching valve 5, the first bypass passage 13, the three-way valve 16, the temperature type expansion valve 7, the indoor evaporator 8 and the accumulator 9, as shown in FIG. 5. The high-temperature and high-pressure refrigerant compressed by the compressor 3 radiates heat to the air by the indoor condenser 4. The refrigerant which comes to a low temperature by the heat radiation and is set to a low pressure by the temperature type expansion valve 7 absorbs heat from the air by the indoor evaporator 8. Accordingly, the air blasting passing through the inner side of the air conditioning case 12 is cooled by the indoor evaporator 8, and all thereof is reheated by the indoor condenser 4. As a result, the air passing through the inner side of the air conditioning case 12 is controlled to a hot air having a desired temperature.

In the outside air heat absorbing heating operation, the channel switching valve 5 is switched to the second switching position in FIG. 3(b), that is, in such a manner that the refrigerant flows to the outdoor heat exchanger 6 side via the orifice 5i, and the three-way valve 16 is switched in such a manner that the refrigerant flows to the second bypass passage 15 side, respectively. The air mix door 14 is switched, for example, to a full-open position.

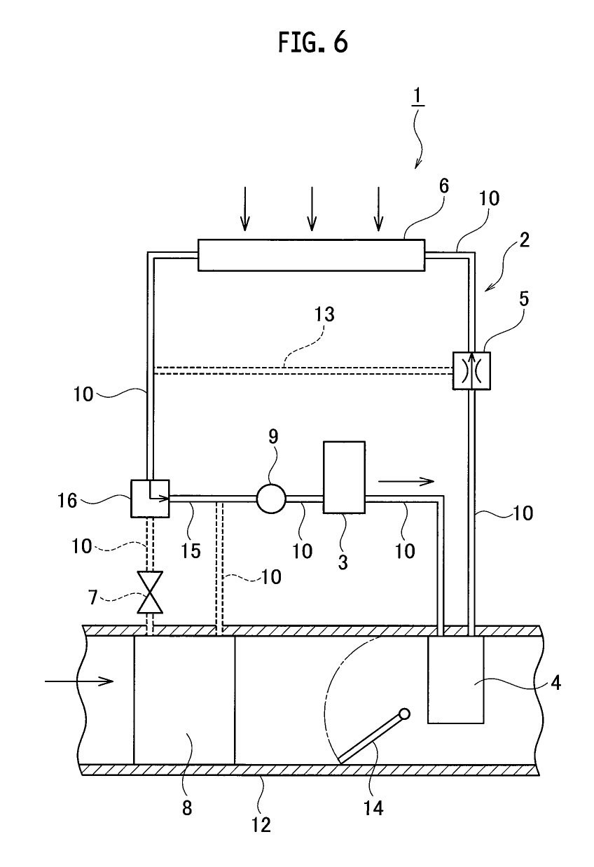

The refrigerant compressed by the compressor 3 circulates in a refrigerant route which passes through the indoor condenser 4, the channel switching valve 5 (the orifice 5i), the outdoor heat exchanger 6, the three-way valve 16, the second bypass passage 15 and the accumulator 9, as shown in FIG. 6. The high-temperature and high-pressure refrigerant compressed by the compressor 3 radiates heat to the air by the indoor condenser 4. The refrigerant which comes to a low temperature by the heat radiation and is set to a low pressure by the passing through the orifice 5i of the channel switching valve 5 absorbs heat from the air by the outdoor heat exchanger 6. Accordingly, the air blasting passing through the inner side of the air conditioning case 12 passes through without being cooled by the indoor evaporator 8, and is heated by the indoor condenser 4. As a result, the air passing through the inner side of the air conditioning case 12 is controlled to a hot air having a desired temperature. In the outside air heat absorbing heating operation, since the refrigerant does not carry out the heat absorbing action in the indoor evaporator 8 and the air is not cooled, a greater heating performance than the inside air heat absorbing heating operation can be obtained.

As described above, it is possible to selectively switch the communication between the refrigerant inlet 5d and each of the refrigerant outlets 5e and 5f in the housing 5a by actuating the valve body 5b which is movably accommodated in the housing 5a, and it is possible to switch between the flow passage which passes through the orifice 5i and the flow passage which does not pass through the orifice 5i. Accordingly, it is possible to switch the refrigerant route and decompress the refrigerant. Therefore, since it is possible to reduce the number of the valve elements, it is possible to reduce a cost, a weight and an installing space. Further, since a piping joint between the valve elements is not necessary, it is possible to reduce a connecting work man hour. Further, since it is possible to reduce the number of the wiring connectors and the harness connecting man hour by reducing the valve element controlling coils, it is possible to hold down the cost in this regard.

In this embodiment, since the installing space of the valve body 5b can be made small by constructing the valve body 5b of the channel switching valve 5 by the ball valve which can vary the switching position by the rotation, it is possible to achieve a compact structure of the channel switching valve 5.

In this embodiment, since it is possible to partly communicate between the refrigerant inlet 5d and the first refrigerant outlet 5e or the second refrigerant outlet 5f in the switching process of each of the switching positions of the valve body 5b, it is possible to avoid a state in which the refrigerant channel is closed by the valve body 5b, that is, a so-called dead end state.

In the embodiment mentioned above, a diameter of the orifice 5i becomes smaller due to a factor such as a characteristic of the orifice 5i, a hole workability and a sound vibration generation, and a hole center displacement is generated, so that there can be thought a case that the channel switching valve 5 is fully closed in the process of switching to each of the switching positions, as shown in FIG. 4(b). In this case, the control unit 11 may be structured such as to control so as to restrict the rotating speed of the compressor 3 in the section that the channel switching valve 5 is fully closed in the process of switching to each of the switching positions. Specifically, a rotary sensor (not shown) detecting a rotational position of the valve body 5b is provided in the actuator 5c of the channel switching valve 5, and the rotating speed of the compressor 3 is lowered or stopped on the basis of a detected signal output from the rotary sensor. According to the structure mentioned above, in the case of the dead end state in which the refrigerant channel is closed by the valve body 5b in the process of switching to each of the switching positions in the valve body 5b, it is possible to protect the compressor 3 from being damaged by continuously feeding the high-temperature and high-pressure refrigerant by the compressor 3.

Further, in the embodiment mentioned above, there is exemplified the case that the valve body 5b is constructed by the ball valve, however, the present invention is not limited to this, but may be provided with a columnar valve body.

The present invention claims the benefit of Japanese Patent Application No. 2011-275558 filed on Dec. 16, 2011, which is hereby incorporated by reference herein in its entirety.

### INDUSTRIAL APPLICABILITY

According to the present invention, since it is possible to selectively switch the communication between the refrigerant inlet and each of the refrigerant outlets in the housing by actuating the valve body which is movably accommodated in the housing, and it is possible to switch between the flow passage which passes through the orifice and the flow passage which does not pass through the orifice, it is possible to decompress the refrigerant as well as switching a plurality of refrigerant channels. Therefore, since it is possible to reduce the number of the valve elements by concentrically arranging the valve body, the refrigerant inlet, a plurality of refrigerant outlets, the refrigerant channel and the orifice in one housing, it is possible to reduce the cost, the weight and the installing space in comparison with the conventional case that a plurality of valve elements is independently provided. Further, since a piping joint between the valve elements is not necessary, it is possible to reduce the piping connection workingman hour. Further, since it is possible to reduce the number of the wiring connectors and the harness wiring man hour by reducing the coils for controlling the valve elements, it is possible to hold down the cost in this regard.

### REFERENCE SIGNS LIST

1 vehicle air conditioning device
2 vapor compression type refrigerating cycle
3 compressor
4 indoor condenser
5 channel switching valve
5a housing
5b valve body (ball valve)
5d refrigerant inlet
5e first refrigerant outlet (refrigerant outlet)
5f second refrigerant outlet (refrigerant outlet)
5i orifice
6 outdoor heat exchanger
8 indoor evaporator
13 first bypass passage (bypass passage)

1. A channel switching valve comprising:
a housing having a refrigerant inlet and a plurality of refrigerant outlets through which a refrigerant flows in and out;
a valve body having refrigerant channels which are movably accommodated in the housing and can selectively switch communication between the refrigerant inlet and each of the refrigerant outlets, wherein
the refrigerant channels are partly constructed by an orifice, and can be selectively switched between a route which passes through the orifice and a route which does not pass through the orifice.

2. The channel switching valve according to claim 1,
wherein the housing has:
a refrigerant inlet to which the refrigerant passing through an indoor condenser which performs heat exchange between the refrigerant compressed by a compressor and air supplied into a passenger compartment and heats the air is conducted; and
a first refrigerant outlet which conducts the refrigerant to an outdoor heat exchanger performing heat exchange between the refrigerant and air outside the passenger compartment, and a second refrigerant outlet which conducts the refrigerant to a bypass passage flowing the refrigerant to an indoor evaporator performing heat exchange between the refrigerant and air inside the passenger compartment while bypassing the outdoor heat exchanger, and
wherein a valve element of the valve body can be switched among a first switching position which communicates between the refrigerant inlet and the second refrigerant outlet, a second switching position which communicates between the refrigerant inlet and the first refrigerant outlet by a switching channel passing through the orifice, and a third switching position which communicates between the refrigerant inlet and the first refrigerant outlet.

3. The channel switching valve according to claim 2,
wherein the valve element is a ball valve which can vary the switching position by rotation.

4. The channel switching valve according to claim 2,
wherein in a switching process of each of the switching positions, the switching position can be switched by partly communicating between the refrigerant inlet and the first refrigerant outlet or the second refrigerant outlet.

5. The channel switching valve according to claim 2,
wherein a control for restricting a rotating speed of the compressor is carried out, in a section which is fully closed in the switching process to each of the switching positions.

6. A vehicle air conditioning device comprising:
a compressor which compresses a refrigerant;
an indoor condenser which performs heat exchange between the refrigerant compressed by the compressor and air supplied into a passenger compartment so as to heat the air;
an outdoor heat exchanger which performs heat exchange between the refrigerant and air outside the passenger compartment;
an indoor evaporator which performs heat exchange between the refrigerant and the air supplied into the passenger compartment so as to cool the air; and
a channel switching valve having a refrigerant inlet to which the refrigerant passing through the indoor condenser is conducted, a first refrigerant outlet which flows the refrigerant to the outdoor heat exchanger, and a second refrigerant outlet which conducts the refrigerant to a bypass passage bypassing the outdoor heat exchanger, and being capable of switching among a first switching position which communicates between the refrigerant inlet and the second refrigerant outlet, a second switching position which communicates between the refrigerant inlet and the first refrigerant outlet by a switching channel passing through an orifice, and a third switching position which communicates between the refrigerant inlet and the first refrigerant outlet.
